(19) United States
(12) Patent Application Publication
(10) Pub. No.: US 2011/0040889 A1
(43) Pub. Date: Feb. 17, 2011

(54) MANAGING CLIENT REQUESTS FOR DATA

(76) Inventors: Owen John Garrett, Ely (GB); Declan Sean Conlon, Cambridge (GB); Matthew Morgan Horney, Cambridge (GB)

Correspondence Address: FAY SHARPE LLP, 1228 Euclid Avenue, 5th Floor, The Halle Building, Cleveland, OH, 44115, US

(21) Appl. No.: 12/853,729

(22) Filed: Aug. 10, 2010

(30) Foreign Application Priority Data
Aug. 11, 2009 (EP) 09 251 974.3

(51) Int. Cl. G06F 15/16

(52) U.S. Cl. 709/232

(57) ABSTRACT

Network traffic is distributed between a plurality of networked computers. The traffic comprises requests that are received into the network and replicated to each computer. For each request, each computer makes a decision based on attributes of the request as to whether to process or ignore the request, such that each request is processed by only one computer. Each computer periodically broadcasts a signal to each of the other computers to confirm that it is online. When a first computer is no longer online, the traffic is redistributed amongst the remaining online computers, wherein traffic that is already processed by the remaining computers is not redistributed, traffic that would have been processed by the first computer is split evenly between the remaining computers, and each computer decides independently and identically how to redistribute the traffic without communicating with the other computers.

### CROSS REFERENCE TO RELATED APPLICATIONS

This application claims priority from European Patent Application No. 09 251 974.3, filed 11 Aug. 2009, the whole contents of which are incorporated herein by reference in their entirety.

### BACKGROUND OF THE INVENTION

1. Field of the Invention

The present invention relates to a method of distributing network traffic between a plurality of networked computers.

2. Description of the Related Art

Many situations arise in which a very large number of clients, possibly browsing the Internet, require access to a particular data source, such as a highly popular website. In order to serve data to many clients of this type, it known to make the data available from many servers acting as a collection with traffic management systems being used to even out loading in an attempt to optimise the available functionality.

However, it is also necessary that the traffic managers (also referred to as load balancers) also have even load balancing so that client requests may be served as quickly as possible. To solve this problem, it is known to have a plurality of IP addresses, each of which is monitored by a different traffic management system. Requests are allocated randomly to the available IP addresses, meaning that the load is spread evenly. However, in an environment of this type, problems may occur if traffic managers become inoperative. A typical solution is that when one traffic manager fails, another takes over monitoring its IP address, meaning that one traffic manager is now processing twice the amount of traffic as the others. Should that traffic manager fail in turn, which is possible given the extra load, a third traffic manager will have to deal with three times as much traffic as the remaining traffic managers.

Further issues with multiple IP addresses are that they are a limited resource, and that it is preferable to present a single point of entry to clients.

### BRIEF SUMMARY OF THE INVENTION

According to an aspect of the present invention, there is provided a method according to claim 1.

### BRIEF DESCRIPTION OF THE SEVERAL VIEWS OF THE DRAWINGS

FIG. 1 shows an environment suitable for embodying the invention;

FIG. 2 shows the internal components of a traffic manager shown in FIG. 1;

FIG. 3 details steps carried out by the traffic manager shown in FIG. 2;

FIG. 4 illustrates the contents of the memory shown in FIG. 2;

FIG. 5 is an illustration of request handling by the traffic managers shown in FIG. 1;

FIG. 6 is an illustration of how traffic is redistributed between online traffic managers;

FIG. 7 details steps carried out in FIG. 3 to determine responsibility for a request;

FIG. 8 gives examples of the responsibilities table shown in FIG. 4;

FIG. 9 details steps carried out in FIG. 7 to calculate a responsibilities table;

FIG. 10 illustrates how buckets are distributed between online traffic managers; and

FIG. 11 shows the weight of a permutation of the set of traffic managers.

### DESCRIPTION OF THE BEST MODE FOR CARRYING OUT THE INVENTION

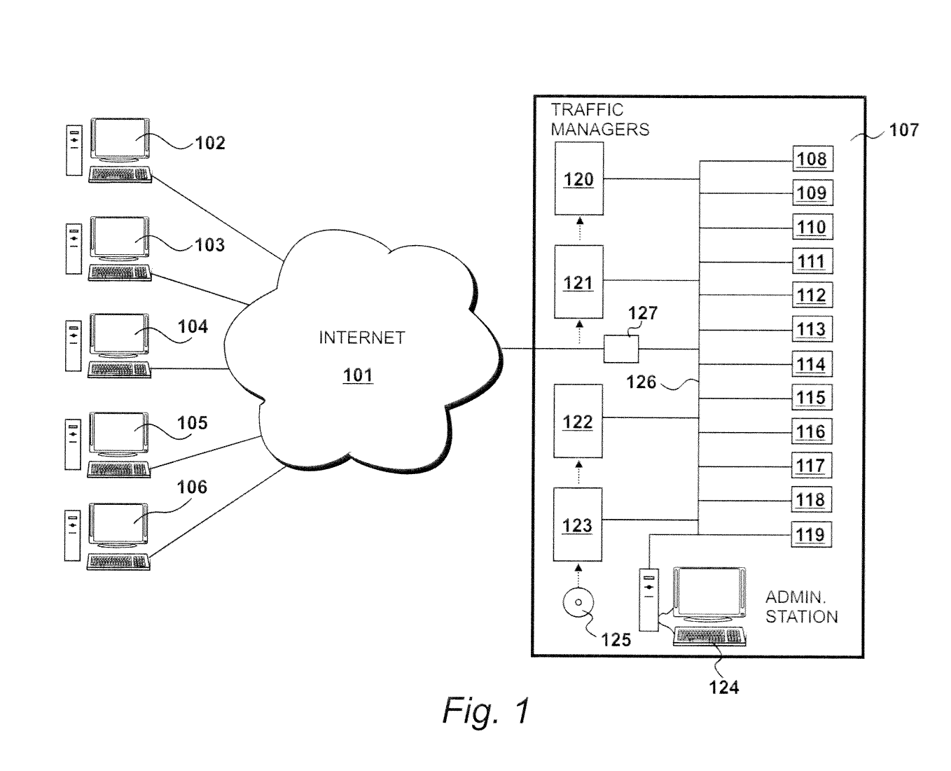

### FIG. 1

The following embodiment is described with respect to accessing data over the Internet, although it should be appreciated that the techniques involved have applications in other networked environments.

The Internet is illustrated at 101 and receives requests from many browsing clients, a small number of which are illustrated as browsing clients 102 to 106.

A service provider 107 includes servers 108 to 119, traffic managers 120 to 123, an administration station 124, traffic manager instructions encoded onto a CD-ROM 125 or similar data carrying medium, and an internal network 126 and a router 127.

In this example, the service provider 107 has a single URL and is configured to provide information from a popular website to a significantly large number of browsing clients. A domain name server (DNS) on the Internet associates this URL with a single IP address. When a browsing client wishes to access the website a request is sent to this IP address which is received by router 127. Router 127 replicates this request to each of the traffic managers 120 to 123. Each traffic manager then makes a decision about whether or not it is responsible for this request. Only one traffic manager is responsible for each request, and that traffic manager processes it. Every other traffic manager drops the request, not even acknowledging it. By ensuring an even spread of responsibility across the traffic managers, the load on the traffic managers is distributed evenly.

Each traffic manager, such as traffic manager 120, receives a client request (an HTTP request) and analyses it, in part or completely, in order to decide which server 108 to 119 to convey the request to. It may decide this according to several criteria. For example, it may wish to simply spread the load, in which case it will choose the least loaded server. Traffic management, however, usually involves selecting servers on the basis of their functionality. In such a scenario, servers are grouped into pools. A first pool may serve static web pages, a second pool may serve dynamic content and a third pool may serve secured data over an HTTPS connection. The traffic manager 120 chooses which to access, based upon the type of request. Thus, this additional functionality may be considered as identifying the difference between traffic management compared to basic load balancing.

The administration station is used to remotely configure the traffic managers and the servers, such that it is not necessary to provide the traffic managers and servers with an output monitor or a keyboard input etc. Consequently, these systems have a hardware implementation that consists of a one- or two-unit rack mounted device connected to a network. The administration station is also used for installing instructions, including server instructions and traffic managing instructions.

The CD-ROM 125 containing traffic managing instructions may be loaded directly onto the traffic managers 120 to 123 if they have CD-ROM drives, or instructions from the CD-ROM can be installed from the CD-ROM drive of the administration station 124 via the network 126 onto the traffic managers 120 to 123.

In the present embodiment, service requests are managed in a system having many servers for serving clients in response to one address, under the supervision of a set of traffic managers, whereby each request is handled by only one traffic manager. Each of the traffic managers is configured such that firstly it intermittently transmits its availability to the other traffic managers. Secondly, it identifies a change in the availability of the other traffic managers in the set. Thirdly, it modifies its responsibilities for traffic in response to the identified change of availability. In this way, it is possible to balance incoming service requests against the availability of the traffic managers.

This system would be suitable for any environment where a network of computers services incoming client requests. In this embodiment the computers are traffic managers, but in other embodiments they could be computers having other functions, provided that each computer is configured to process a request in an identical way.

Each traffic management system, in this embodiment, issues a multicast on a periodic basis informing the other traffic management systems to the effect that the traffic management system is online. In this example, online means available for use. A traffic manager may go offline because of a crash or simply because it is overworked and does not have enough memory to issue the multicast. Failure to receive a multicast in this way identifies to the other servers that availability has been lost. Each then independently determines its responsibility for incoming requests, without resort to central information and without negotiating with the other traffic managers.

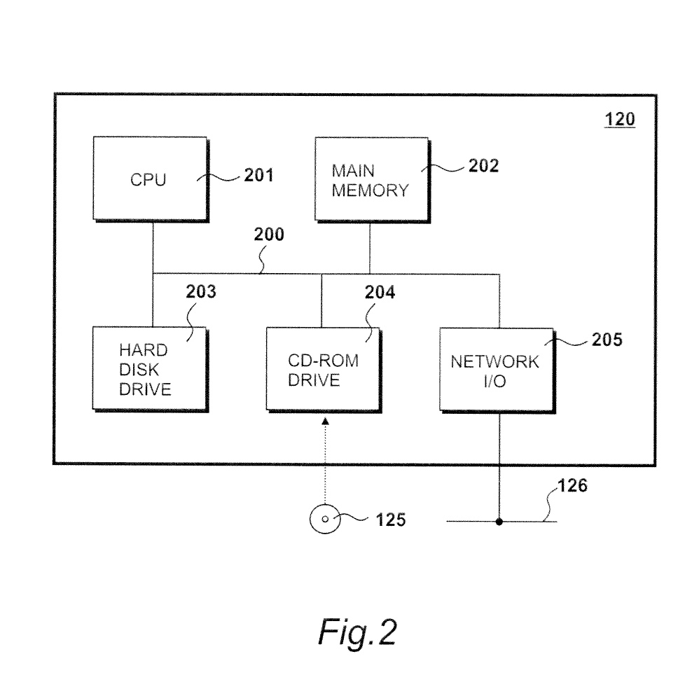

Details of the hardware configuration for a specific traffic manager 120 is illustrated in FIG. 2.

### FIG. 2

All traffic managers 120 to 123 are substantially the same, and the servers 108 to 119 are similarly configured.

Internally, components of the traffic manager communicate over a system bus 200. The central processing unit 201 may be a Pentium 6 running at 5.2 gigahertz and includes on-chip primary and secondary cache, to facilitate access to frequently used instructions and data.

A main memory 202 provides, for example, 2 gigabytes of dynamic RAM, in which instructions and data are stored for regular access while the system is operating. A hard disk drive 203 provides typically 60 gigabytes of non-volatile storage of instructions and configuration data. The disk 203 also provides storage for infrequently accessed data, such as configuration files, that are loaded into main memory when the system is initialised.

In this example, a CD-ROM drive 204 is shown which, as previously stated, is configured to receive the data carrying medium, such as a CD-ROM, so as to facilitate the loading of instructions for implementing the traffic management functionality. Communication to network 126 is provided via a network interface card 205.

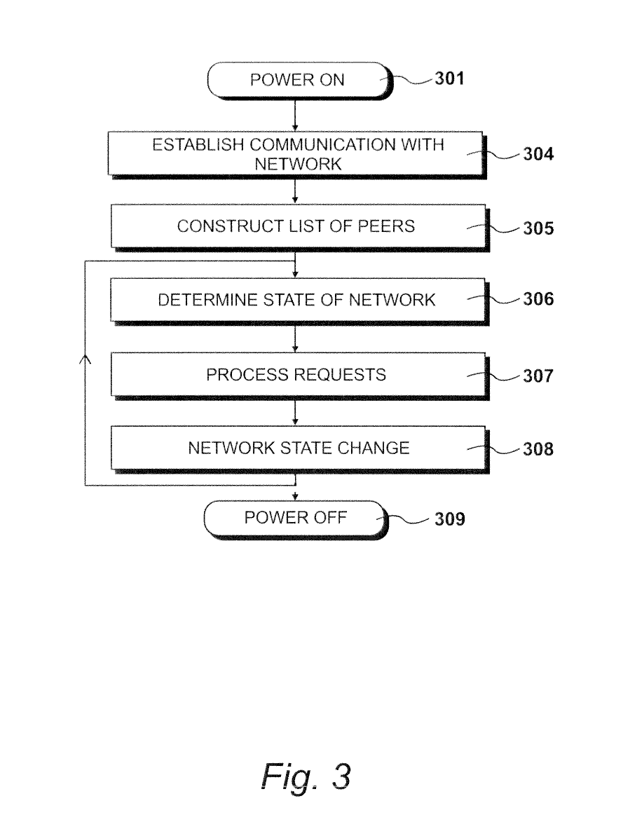

Procedures for implementing operation of the system are illustrated in FIG. 3.

### FIG. 3

At step 301 traffic manager 120 is powered on and at step 302 a question is asked as to whether the traffic manager instructions are installed. If the traffic manager is new on the network this question will be answered in the negative and instructions are installed at step 303, for example from a computer-readable medium such as CD ROM 125 or from the network 126.

Following this, and if the question asked at step 302 is answered in the affirmative, then at step 304 the traffic manager 120 establishes communication with its peers, ie the network of traffic managers comprising traffic managers 121, 122, and 123. This includes setting up a multicast MAC address so that the router can multicast an incoming request to all the traffic managers' MAC addresses. In this step, the computer constructs a MAC address from a particular IP address, and informs router 127 that this MAC address should be used for multicasts of the IP address. Thus when a request arrives for that IP address, the router is aware of which MAC addresses to multicast it to.

Information is available from router 127 regarding the total number of active traffic managers on the network, and thus at step 305 the traffic manager constructs a list of its peers. This is an ordered list, in this embodiment alphabetically, and each traffic manager holds an identically ordered list.

At step 306 traffic manager 120 determines the state of the network, i.e. which of its peers are online. This is done by listening for multicasts from the other traffic managers, sent twice a second, indicating that they are online. In turn, traffic manager 120 multicasts twice a second that it is online. In this way each traffic manager is continually aware of the online availability of its peers. These twice-a-second multicasts are called heartbeats. In other embodiments they may be sent at a different regular interval.

At step 307 the traffic manager processes incoming requests until a network state change, ie a traffic manager going offline or returning online, at step 308 provides an interrupt, after which control is returned to step 306 and the state of the network is determined.

Steps 306, 307 and 308 are continued until the traffic manager is powered off, either intentionally for maintenance or due to a systems crash.

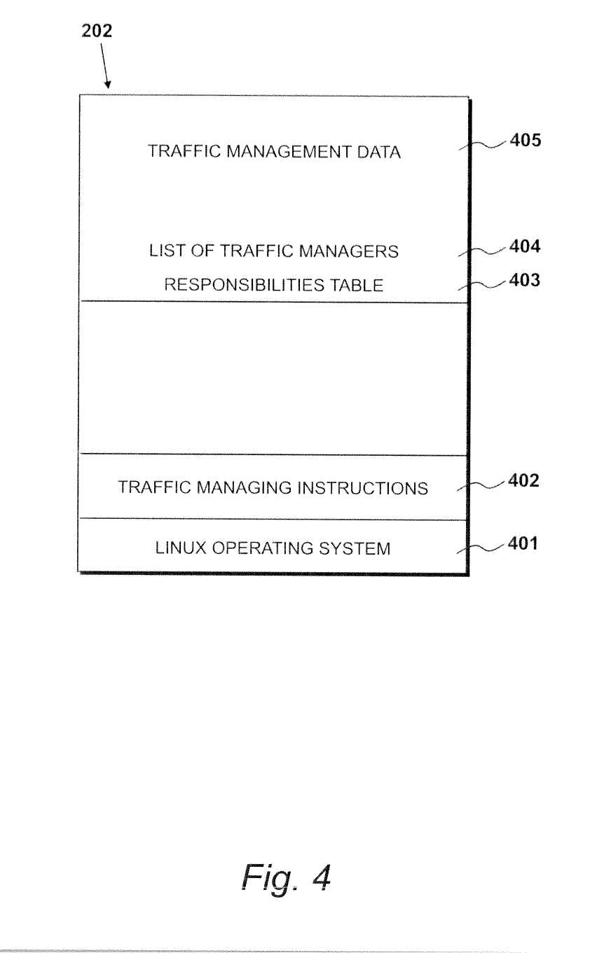

A mapping of instructions and data held within main memory 202, when operational, is illustrated in FIG. 4.

### FIG. 4

As part of the loading process an operating system, such as Linux® or an alternative, is loaded at 401.

The traffic managing instructions themselves are loaded at 402. A responsibilities table is illustrated as being located at 403 and the list of traffic managers created at step 305 is held at location 404. Location 405 provides space for the storage of traffic management data.

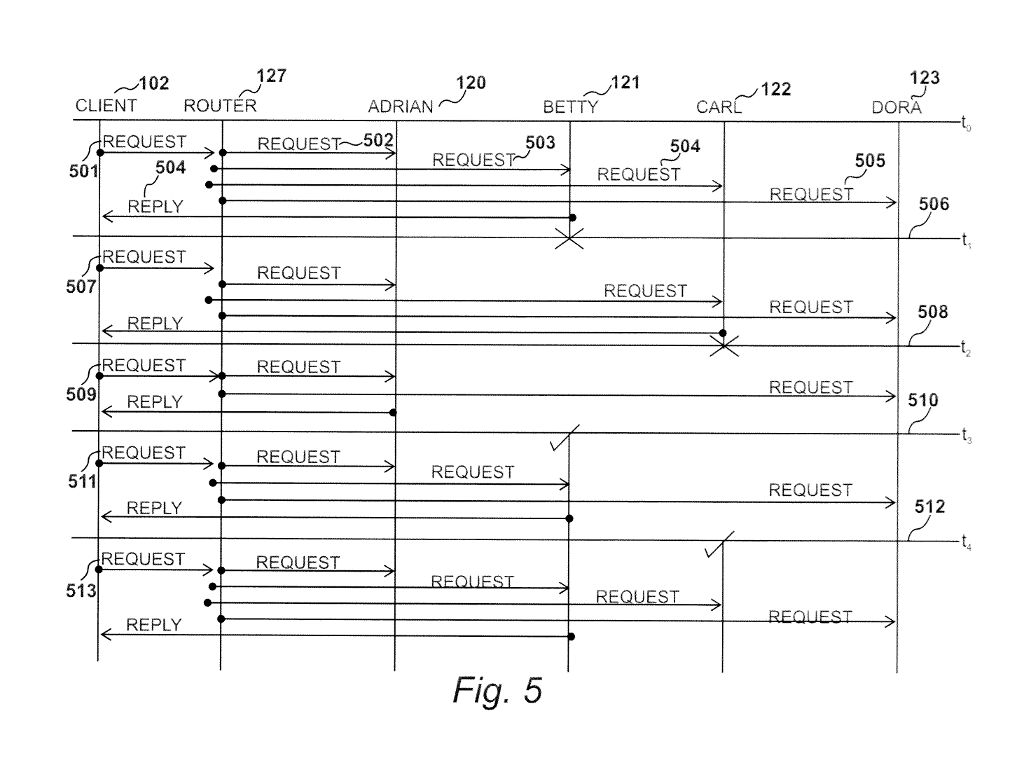

### FIG. 5

FIG. 5 illustrates a handling of requests by traffic managers 120 to 123. In this example, each traffic manager has been given a name. Thus traffic manager 120 is named Adrian, traffic manager 121 is named Betty, traffic manager 122 is named Carl, and traffic manager 123 is named Dora. The alphabetical list of traffic managers therefore comprises traffic managers 120, 121, 122 and 123 in that order.

At time t₀, indicated at 500, all the traffic managers are online. A client request 501 is received from client 102 at router 127. This request is then multicast to traffic manager 120 as request 502, to traffic manager 121 as request 503, to traffic manager 122 as request 504, and to traffic manager 123 as request 505. Each traffic manager consults its responsibilities table 403 and traffic manager 121 determines that it is responsible for this request. It therefore sends reply 504. Each of traffic managers 120, 122 and 123 determines that it is not responsible for the request and ignores it.

At time t₁ indicated at 506, traffic manager 121 suffers a failure. Traffic managers 120, 122 and 123 fail to receive a heartbeat from traffic manager 121 and they therefore reconfigure their responsibilities table to ensure that traffic that would have been handled by traffic manager 121 is evenly redistributed.

Request 507 is then received by router 127. This is also a request from client 102 and thus would normally have been handled by traffic manager 121. The request is multicast to traffic managers 120, 122 and 123 and traffic manager 122 determines that it is responsible for the request and sends a reply. Traffic managers 120 and 123 ignore it.

At time t₂, indicated at 508, traffic manager 122 also fails. Traffic managers 120 and 123 reconfigure their responsibilities table, and thus when request 509 is received from client 102, it is handled by traffic manager 120. At time t₃, indicated at 510, traffic manager 121 comes back online. It resumes its responsibilities and also takes from traffic managers 120 and 123 a share of the traffic normally handled by traffic manager 122. Thus when request 511 is received from client 102 by router 127, it is multicast to traffic managers 120, 121 and 123. Traffic manager 121 is responsible for it and thus sends a reply.

At time t₄, indicated at 512, traffic manager 123 comes back online. It takes back its responsibilities from the other traffic manages and each of the responsibilities tables looks identical to how it did at time t₀. Thus, when request 513 arrives from client 102 it is handled by traffic manager 121.

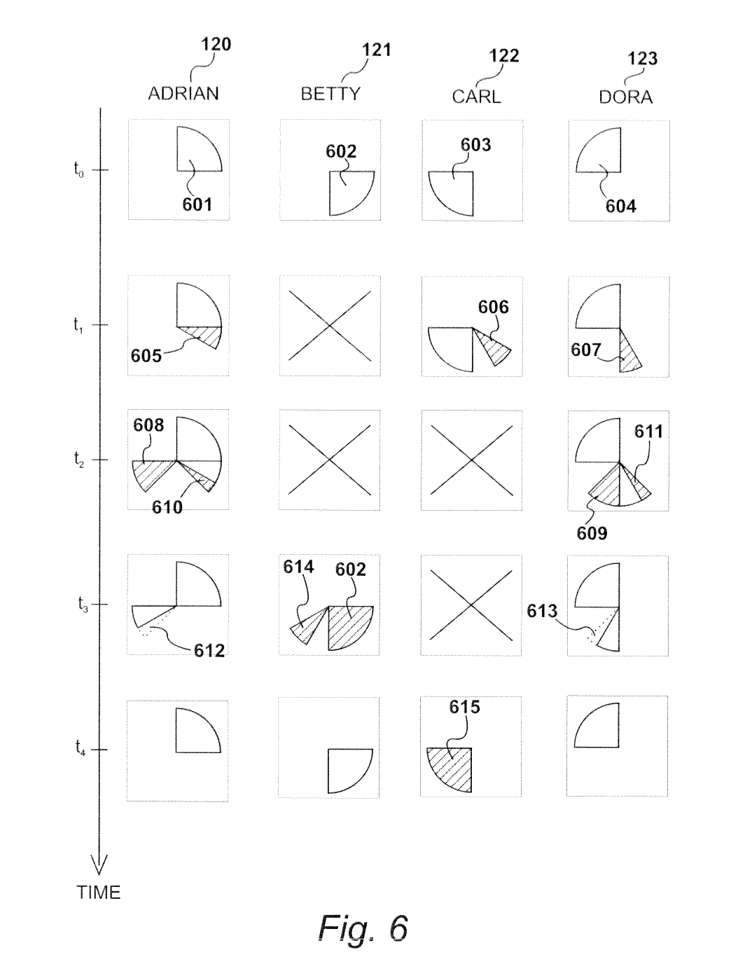

### FIG. 6

An illustration of how the responsibility for traffic is distributed between the traffic managers is shown in FIG. 6. If the entirety of the traffic at any one time is considered as a circle, then each of the four traffic managers has an equal share of the circle at time t₀. Thus traffic manager 120 has a quarter 601 of the traffic, traffic manager 121 has a quarter 602 of the traffic, traffic manager 122 has a quarter 603 of the traffic, and traffic manager 123 has the last quarter 604 of the traffic.

At time t₁ traffic manager 121 goes offline. Its quarter of the traffic 602 is divided into three and split between the remaining traffic managers. Thus traffic managers 120, 122 and 123 each take on portions 605, 606 and 607 respectively. Their original quarters remain unchanged.

At time t₂ traffic manager 122 also fails. Its traffic is therefore shared evenly between traffic managers 120 and 123. It original quarter 603 splits evenly as portions 608 and 609, and the portion 606 of the traffic taken from traffic manager 121 is split equally as portions 610 and 611. The traffic already handled by traffic managers 120 and 123, including portions 605 and 607 taken from traffic manager 121, is not redistributed.

At time t₃ traffic manager 121 comes back online. It takes back its original quarter of the traffic 602. It also takes a share of traffic manager 122's quarter. Thus, portions 612 and 613 are taken from traffic managers 120 and 123 respectively to form portion 614. As little as possible of the traffic handled by traffic managers 120 and 123 is therefore redistributed.

At time t₄ traffic manager 122 comes back online. It takes back its traffic that has been distributed between traffic managers 120, 121 and 123 as portion 615. The network configuration at time t₄ is now identical to how it was at time t₀.

It will be noted that had traffic managers 121 and 122 failed in reverse order, the effect of which can be seen by viewing the timeline backwards from time t₄, the responsibilities would have been distributed in the same way by time t₂. Thus the present invention provides a system in which computers decide independently and identically what the responsibilities are of each of its peers on the network. For example, if two computers failed at substantially the same time, it would be necessary in many prior art systems for the remaining computers to negotiate about the order in which the offline computers failed, in order to ensure that responsibilities are distributed evenly. However, the present invention requires no negotiation between traffic managers.

Furthermore, when a traffic manager goes offline, its responsibilities are redistributed between the remaining traffic managers, but the responsibilities already held by these remaining traffic managers are not changed. This is important because if responsibilities change while a series of client requests are being processed, communication can be lost, leading to annoyance on the part of the client. When a traffic manager comes back online, clearly responsibilities must be removed from an online traffic manager, but the amount of traffic redistributed is minimised.

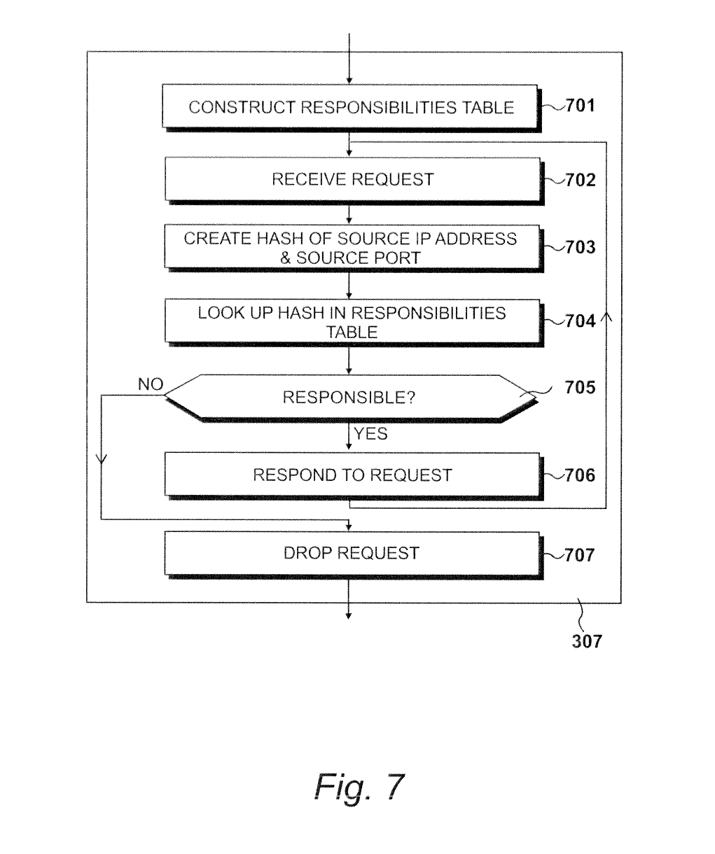

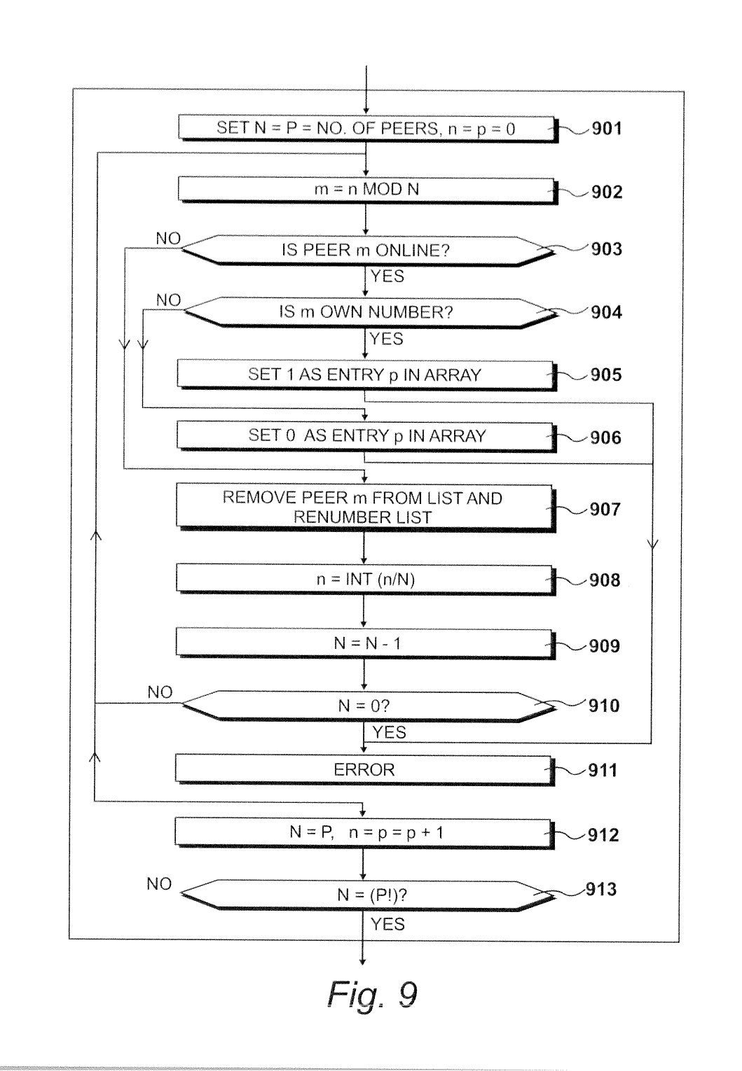

This invention is implemented by an algorithm described with respect to FIGS. 7 and 9.

### FIG. 7

FIG. 7 details step 307 carried out by traffic manager 120, and identically by each of the other traffic managers.

At step 701 responsibilities table 403 is constructed and at step 702 a request is received from router 127. At step 703 a hash is created of the source IP address and, optionally, the source port of the request, and at step 704 this hash is looked up in responsibilities table 403.

At step 705 a question is asked as to whether traffic manager 120 is responsible for requests having this hash, as shown in responsibilities table 403, and if this question is answered in the affirmative then the request is responded to at step 706. Alternatively, the request is dropped at step 707.

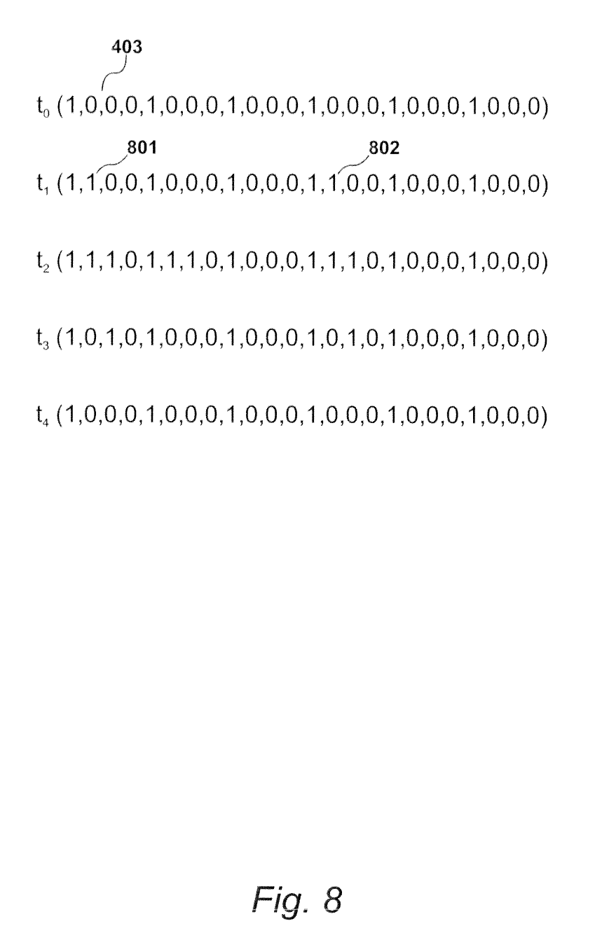

### FIG. 8

FIG. 8 illustrates responsibilities table 403 held by traffic manager 120 during the various changes of responsibilities illustrated in FIG. 6. The responsibilities table 403 is a bit array having dimension N!, where N is the number of peers in the network. Thus in this example the array has 4!=24 entries. Six of these entries are 1 and eighteen are 0. The hash function used at step 703 creates an integer between 0 and 23. Thus the traffic is split into twenty-four “buckets” and each request falls into one of these buckets depending on its hash. As shown in responsibilities table 403, at time t₀ traffic manager 120 is responsible for buckets 0, 4, 8, 12, 16 and 20.

The hash function used in this embodiment is the Jenkins Hash which reduces the IP address and the source port to an integer. This integer is then reduced to a number between 0 and N!−1 (23 in this example) using reduction modulo N!. Other hash functions could be used, and in other embodiments only the IP address is used to make the hash. Other attributes of the request could also be hashed. The advantage of using a hash is that it maps a wide range of values, such as the IP address, to a set number of buckets evenly and deterministically, with no statistical affinity between original values that are adjacent to each other. Thus no matter how unevenly spread IP addresses are, the hash always distributes traffic evenly over the buckets. The task then is to ensure that the buckets are evenly distributed over the traffic managers.

At time t₁ traffic manager 121 goes offline and its six buckets are distributed evenly between the three remaining traffic managers, thus giving each of the traffic managers a further two buckets. Thus, traffic manager 120 is now responsible for buckets 1, indicated at 801, and thirteen 13, indicated at 802. Its existing buckets have not changed.

At time t₂, when traffic manager 122 also goes offline, its eight buckets are split between the remaining two traffic managers. Thus traffic manager 120 becomes responsible for buckets 2, 5, 6 and 14.

At time t₃ when traffic manager 121 comes back online, it takes back its existing buckets plus a share of the offline traffic manager 122's buckets. Thus, in addition to its own buckets traffic manager 120 now only has buckets 2 and 14. At time t₄ traffic manager 122 comes back online and takes these buckets back.

By using N! buckets, the invention described herein ensures that an offline traffic manager's load can always be distributed evenly between the remaining traffic managers.

### FIG. 9

Steps carried out at step 703 to create responsibilities table 403 are detailed in FIG. 9. At step 901a variable N and a variable P are set to be the number of peers in the network, irrespective of how many are online, while iterative variables n and p are set to zero. At step 902 a variable m is set to be n modulo N. At step 903 the list of peers 504 is consulted to determine which traffic manager is at position m in the list, and the question is asked as to whether this traffic manager is online. If this question is answered in the affirmative then a further question is asked as to whether this peer is the traffic manager itself and if this question is answered in the affirmative then at step 905 the entry at position p in responsibilities table 403 is set to be 1. If it is answered in the affirmative then the entry is set to 0 at step 906. Thus if all the traffic managers are online, then all the buckets with numbers that are congruent modulo N are allocated to the same traffic manager.

However, if the question asked at step 903 is answered in the negative, to the effect that the peer with number m is offline, then at step 907 this peer is removed from the list to create a new, renumbered list. At step 908 the variable n is set to be the integer part of the division of n by N. This has the effect of renumbering the buckets that should be handled by the offline traffic manager from 0 to (N−1)!. Therefore at step 909 N is decremented by 1, and after checking at step 910 that N is not equal to zero control is returned to step 902 where a new value of m is calculated for the new values of n and N.

This value is then checked against the new, renumbered list. If the peer it indicates is also offline, then the process is reiterated. Eventually, either N will equal zero, in which case all the traffic managers have failed and an error is thrown at step 911, or the bucket will be allocated to an online peer. Following this, at step 912 N is reset to be P, p is incremented by one, and n is set to this new value of p. At step 913 a question is asked as to whether n is now equal to P!. If this question is answered in the negative then control is returned to step 902 and the process of deciding which traffic manager has responsibility for the next bucket is started. Alternatively, all the buckets have been considered and the responsibilities table has been constructed.

The algorithm described with respect to FIG. 9 can be carried out on the hash of every request that comes in to determine responsibility on a request-by-request basis, rather than to produce a responsibilities table. This will generally not be more efficient. However, with a large number of traffic managers a bit array of size N! will become sparse and slow. A lookup tree may be the solution, but when there are many traffic managers it may become quicker to perform the algorithm every time.

Redundant or spare computers can be incorporated into the system described herein. For example, a service provider may only have enough traffic for two traffic managers but wish to have three or even four for the purposes of reliability. It is more efficient, in terms of power and time, to only run two traffic managers in this situation and mark the other two as passive. This means that they are not considered to be online peers when the responsibilities table is constructed. The algorithm still, however, uses an initial value of four peers and constructs a responsibilities table of size twenty-four. Should one of the active machines go offline, one or more of the passive machines goes online and takes its place in the algorithm.

In an alternative embodiment of this invention, the traffic managers can be weighted. If one of the computers is considerably more powerful than the others, it may be preferable for it to always handle more traffic. This can be done by considering the powerful computer to have two places in the list of computers, thus increasing the total number of computers by one more than is actually there. However, this also increases the size of the responsibilities table, which may become sparse and inefficient.

An alternative implementation is as follows. The algorithm described above can be considered as a method for selecting one of the N! permutations of the set of traffic managers, and selecting the first working traffic manager from that permutation. The algorithm can be weighted by assigning more hash values to one permutation than another. Each traffic manager is assigned a weight, and for a given permutation, a list of weights w₀, w₁, . . . , w_{N-1} can be created by ordering the traffic manager weights in accordance with the order of the permutation. For example, if the weights of traffic managers A, B, C and D were w_{A}, w_{B}, w_{C}, w_{D} then for the permutation (C, B, A, D) the list of weights would be w₀=w_{C}, w₁=w_{B}, w₂=w_{A}, and w₄=w_{D}.

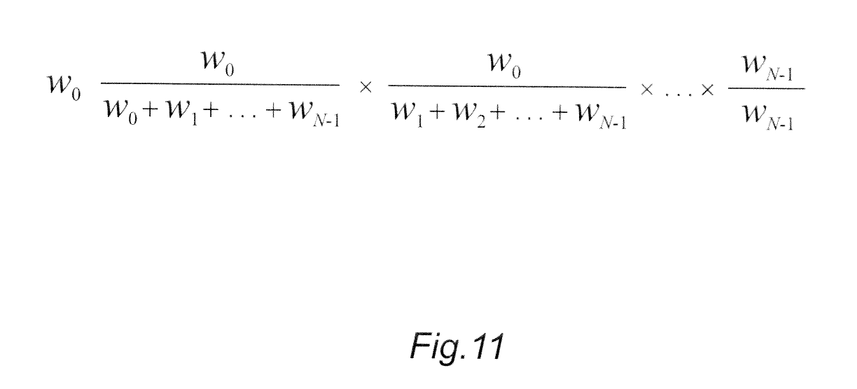

The weight for a permutation is illustrated in FIG. 11.

The N! different permutation weights sum to 1. They are ordered in the same order as the N! permutations that are generated by the algorithm above. The hash is mapped to a value between 0 and 1 (for example by dividing by the size of the hash space) and the weights are considered cumulatively until the sum of the weights is higher than the mapped value. The last weight to be added indicates the permutation to use for that hash.

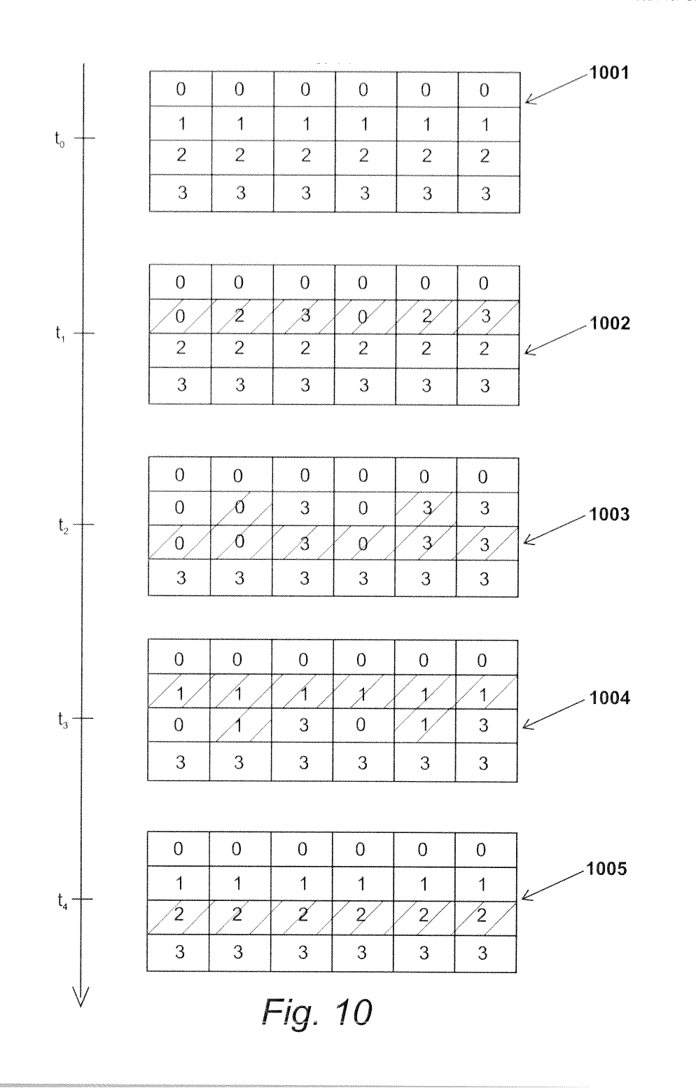

### FIG. 10

FIG. 10 illustrates the allocation of buckets performed by the algorithm described with respect to FIG. 9. Although the algorithm actually results in the production of a bit array as shown in FIG. 8, the illustration in FIG. 10 shows the allocation to each active traffic manager. The twenty-four buckets are set out at 1001 in a 4×6 array. Buckets 0 to 3 are in the first column, buckets 4 to 7 are in the second column, and so on. Thus it can be seen that at t₀ the traffic manager at position 0 in the list, traffic manager 120 named Adrian, is responsible for buckets 0, 4, 8, 12, 16 and 20. The traffic manager numbered 1 in the list, traffic manager 121 named Betty, is responsible for buckets 1, 5, 9, 13, 17 and 21. Traffic manager 122, named Carl, is responsible for buckets 2, 6, 10, 14, 18 and 22, while traffic manager 123, named Dora, is responsible for buckets 3, 7, 11, 15, 19 and 23.

At time t₁ when traffic manager 121 (Betty) goes offline, it can be seen that its six buckets are reallocated between the three remaining traffic managers. Thus traffic manager 121 takes buckets 1 and 13, traffic manager 122 takes buckets 5 and 17, while traffic manager 123 takes buckets 9 and 21. For example, when considering bucket 1:

13 mod 4=1

Traffic manager 1 in the list (A, B, C, D) is B

B is offline

Int(13\4) mod 3=0

Traffic manager 0 in the list (A, C, D) is A

At time t₂ traffic manager 122 (Carl) goes offline and the array 1003 shows that its eight buckets are redistributed between traffic managers 120 and 123, without changing the buckets that these traffic managers are already responsible for.

At time t₃ traffic manager 121 comes back online and as shown at array 1004 takes back its original six buckets. It also takes bucket 6 from traffic manager 120 and 18 from traffic manager 123, and each traffic manager now has eight buckets again. At time t₄ traffic manager 123 comes back online and as shown at array 1005 takes back its original six buckets.

1. A method of distributing network traffic between a plurality of networked computers, wherein:
said traffic comprises requests that are received into said network and replicated to each computer, and
for each request, each computer makes a decision based on attributes of said request as to whether to process or ignore the request, such that each request is processed by only one computer; comprising the steps of:
periodically broadcasting a signal to each of the other computers to confirm that it is online;
determining a condition to the effect that a first computer is no longer online; and
redistributing said traffic amongst the remaining online computers, wherein:
traffic that is already processed by said remaining computers is not redistributed;
traffic that would have been processed by said first computer is split evenly between said remaining computers; and
each computer decides independently and identically how to redistribute said traffic without communicating with the other computers.

2. A method according to claim 1, wherein each said computer makes a decision about whether to process or ignore said request by creating a hash of attributes of said request and determining whether it is responsible for requests having that hash.

3. A method according to claim 2, wherein for any value of said hash, said computer establishes whether it is responsible for requests having that hash by:
(a) creating a first list of said networked computers, said first list being ordered and numbered;
(b) calculating a first variable by taking the modulus of the hash with respect to the number of computers in said list;
(c) identifying the computer at the position in the list indicated by said first variable; and
(d) if said identified computer is said computer, establishing that it is responsible for requests having said hash.

4. A method according to claim 3, further comprising the steps of:
determining that said identified computer is offline;
removing said identified computer from said list to create a second list and numbering said list;
calculating a modified hash by dividing said hash by said number of computers in said first list; and
performing steps (b) and (c) of claim 3 again, replacing said first list with said second list and said hash with said modified hash; and
if said identified computer is said computer, establishing that it is responsible for requests having the unmodified hash.

5. A method according to claim 2, wherein each of said computers calculates a responsibilities table by determining whether it is responsible for requests having each possible hash value, and each computer consults said responsibilities table to determine whether it is responsible for each request.

6. A method according to claim 1, wherein at least one of said computers is passive and is considered to be offline unless one of the other computers goes offline.

7. A method according to claim 1, wherein each of said computers is a traffic manager, a plurality of servers are connected to said network, and each traffic manager is configured to route requests to one of said servers.

8. A traffic manager for processing requests received over a network, comprising a processor, memory and communication means, wherein said processor is configured to:
maintain communication with a plurality of similar traffic managers via said communication means;
receive a request via said communication means;
determine, based on attributes of said request, whether to process or ignore the request;
determine a condition to the effect that a first traffic manager is no longer online; and
allocate to itself a portion of the traffic handled by said first traffic manager without transferring any traffic that it already handles to other traffic managers, and without negotiating with said other traffic managers.

9. A traffic manager according to claim 8, wherein said processor is configured to determine whether to process or ignore said request by creating a hash of attributes of said request and determining whether it is responsible for requests having that hash.

10. A traffic manager according to claim 9, wherein for any value of said hash, said processor is configured to establish whether it is responsible for requests having that hash by:
(a) creating a first list of said traffic managers, said first list being ordered and numbered;
(b) calculating a first variable by taking the modulus of the hash with respect to the number of computers in said list;
(c) identifying the traffic manager at the position in the list indicated by said first variable; and
(d) if said identified traffic manager is said traffic manager, establishing that it is responsible for requests having said hash.

11. A traffic manager according to claim 10, further comprising the steps of:
determining that said identified traffic manager is offline;
removing said identified traffic manager from said list to create a second list and numbering said list;
calculating a modified hash by dividing said hash by said number of traffic managers in said first list; and
performing steps (b) and (c) of claim 10 again, replacing said first is with said second list and said hash with said modified hash; and
if said identified traffic manager is said traffic manager, establishing that it is responsible for requests having the unmodified hash.

12. A traffic manager according to claim 9, wherein said processor is further configured to calculate a responsibilities table by determining whether it is responsible for requests having each possible hash value, and to consult said responsibilities table to determine whether it is responsible for each request.

13. A traffic manager according to claim 8, wherein said traffic manager is further networked to a plurality of servers, and said processor is further configured to route requests to one of said servers.

14. A computer-readable medium having computer-readable instructions executable by a computer such that, when executing said instructions, a computer will perform the steps of:
maintaining communication with a plurality of similar computers via said communication means;
receive a request via said communication means;
determine, based on attributes of said request, whether to process or ignore the request;
determine a condition to the effect that a first computer is no longer online; and
allocate to itself a portion of the traffic handled by said first computer without transferring any traffic that it already handles to other computers, and without negotiating with said other computers.

15. Instructions executable by a computer or by a network of computers such that when executing said instructions said computer(s) will perform a method as defined by claim 1.

16. A computer system programmed to execute program instructions according to claim 15.
